(19) United States
(12) Patent Application Publication
(10) Pub. No.: US 2013/0246439 A1
(43) Pub. Date: Sep. 19, 2013

(54) METHOD AND SYSTEM FOR USING AN INFORMATION SYSTEM

(71) Applicants: Anthony Liekens, Borsbeek (BE); Jeroen De Knijf, Amsterdam (NL); Peter De Rijk, Zoersel (BE); Bart Goethals, Hulshout (BE); Jurgen Del-Favero, Tienen (BE)

(72) Inventors: Anthony Liekens, Borsbeek (BE); Jeroen De Knijf, Amsterdam (NL); Peter De Rijk, Zoersel (BE); Bart Goethals, Hulshout (BE); Jurgen Del-Favero, Tienen (BE)

(73) Assignees: VIB VZW, Gent (BE); UNIVERSITEIT ANTWERPEN, Antwerpen (BE)

(21) Appl. No.: 13/807,915

(22) PCT Filed: Jun. 30, 2011
(86) PCT No.: PCT/EP2011/060999

§ 371 Date: Dec. 31, 2012

Related U.S. Application Data
(60) Provisional application No. 61/360,539, filed on Jul. 1, 2010.

(30) Foreign Application Priority Data
Jul. 1, 2010 (GB) 1011062.5

(51) Int. Cl. G06F 17/30

(52) U.S. Cl. CPC G06F 17/30312
USPC 707/748

(57) ABSTRACT

A computer-implemented method and system for ranking information in an information system comprising linked objects is disclosed. The computer-implemented method comprises computing a prior ranking of all objects in the linked database, obtaining at least one source object, determining the probability of reaching an object taking a step in random walk with restart in the at least one source object(s) based on the adjacency between objects in the information system, and determining a ranking of objects in the information system using the determined probability and applying a correction factor inversely proportional with the computed prior ranking of the objects. An output based on the determined ranking is provided. The present invention also relates to a computer-implemented method and system for providing probable functional relations between at least one source object and a target object, as well as computer-related products therefor.

### CROSS-REFERENCE TO RELATED APPLICATIONS

This application is the national phase entry of International Application No. PCT/EP2011/060999, filed Jun. 30, 2011 designating the United States of America, and published in English on Jan. 5, 2012 as WO 2012/001096 A2, which claims priority under Article 8 of the Patent Cooperation Treaty to EP 1011062.5, filed Jul. 1, 2010, and also claims the benefit under Article 8 of the PCT and under 35 U.S.C. §119(e) of U.S. Provisional Patent Application Ser. No. 61/360,539, filed Jul. 1, 2010, the contents of which are incorporated herein by this reference.

### TECHNICAL FIELD

The invention relates to the field of information system technology. More particularly, the present invention relates to methods and systems for using information systems such as databases, e.g., identification of nodes and identification of relationships between nodes in an information system.

### BACKGROUND

The use of information systems for identifying recommended objects in the information system is performed in a plurality of fields, such as, for example, for finding related people in a person's social network, finding websites with respect to a certain topic, finding information regarding a disease in a biomedical information system, etc. One aspect of using information systems comprises prioritizing information with respect to a set of one or more certain source objects, to find objects that are specifically related to an initial set of one or more contextual objects provided.

Some techniques of finding authorities in a collection of linked objects (people, documents, biomedical concepts) are known. Finding authorities in linked document collections is the primary objective of the PageRank algorithm, as, e.g., described in U.S. Pat. No. 6,285,999. The PageRank algorithm computes authority weights of HTML pages based upon a random surfer model. In this model, a steady-state distribution of the Markov chain is computed where the Markov chain is based on a transition matrix defined by a surfer that uniformly at random follows the page out-links. In order to obtain a steady-state distribution in the random surfer model, a mixture of such a random surfer with a uniform damping/teleportation factor is typically used. In such a setting, a surfer follows an out-link with probability c or jumps to a random node in the network with probability 1−c. PageRank's main objective is thus to find authoritative documents in a linked document collection.

Inventions that focus on finding authoritative objects given an initial set of one or more objects are described, for example, in Tong et al., in Knowledge and Information Systems 2008, Haveliwala et al., in Proceedings of the eleventh international conference on World Wide Web—WWW '02 2002, and Kim et al., in Computer Vision—ECCV 2008. Key observation in these inventions is that the damping factor is used to jump back uniformly at random to one of the initial objects and, in contrast with the PageRank approach, not to any possible object available in the network. In terms of Markov chains, PageRank uses a random walk to obtain the desired probability distribution over the network, the latter approaches adopt a random walk with restarts where the set of nodes to restart the heuristic corresponds to the initial set of objects. In the above-described systems, objects that a priori have a high authoritative value will also have a high a posteriori authoritative value with respect to one or more starting objects, independent of the starting objects.

For some applications, not only finding the probable relevant data but also obtaining a path between a source data object and a target data object is relevant. The problem of deriving a path, e.g., the shortest path, between two objects in an information system, is a long-lasting and well-studied problem in computer science. The shortest path from a source object to a target object in an information system, is typically defined as a simple path (i.e., no loops are allowed) with a minimal edge weight that connects the source with the target. In the case that no edge weights are provided, it is assumed that all edge weights are standard unit cost (i.e., the edge weights are equal to one). One of the first efficient algorithms to solve the shortest path problem works as follows: First, the distance of all objects in the network is set to infinity, except for the source objects, which obtain a value of zero. Second, all objects are marked as unvisited, except for the source object, which is marked as the current object. Then, for all unvisited neighbors of the current object, the shortest distance from the source object via the current object to its neighbors is computed. In case this distance is shorter than the shortest distance known for this neighbor, then the distance is updated with the previously computed shortest distance. For example, if the distance from source to the current object (A) equals 25, and A has a neighbor B at distance 3, then the distance from B via A to the source object equals 28. In the case where this distance is less than an earlier computed distance from source to B, then the (preliminary) shortest distance to B is set to 28. Finally, the unvisited object with the shortest distance to the source object is selected as current object and the procedure is repeated. For sparse networks, that is, a network where there is no direct link between a large majority of the objects in the network, the computational complexity of the previous algorithm is O (|E|+|N| log |N|), where |N| is the number of objects and |E| is the number of links in the network. If one wants to obtain a set of shortest paths having no overlap between their links, also referred to as the arc-disjoint k shortest loopless paths, a straightforward method to compute the k shortest arc-disjoint simple paths is to first compute the shortest path and then remove all links in the network that have been used by this path. Next, the shortest path is added to solution and a new shortest path can be computed over the adjusted network. This procedure terminates when there are no valid paths in the network left or when the desired k paths have been derived.

### DISCLOSURE

It is an object of the embodiments of the present invention to provide good methods and systems for obtaining information in an information system. Such information may, for example, be nodes related to at least one source node or a probable path between a node and at least one source node. It is an advantage of some embodiments according to the present invention that good prioritization of nodes in an information system can be obtained, starting from a set of source nodes provided by the user. It is an advantage of some embodiments according to the present invention that accurate path information between at least one source object and a target object can be obtained.

It is an advantage of embodiments of the present invention that the system and method can provide information in an unsupervised way, without the need of prior domain knowledge from the user.

It is an advantage of embodiments of the present invention that possible user biases and problems with prediction robustness can be avoided.

It is an advantage of embodiments of the present invention that the methods and systems can be applied independent of the type of information network. It may, for example, relate to a person's social network, a biomedical information system, an information system comprising a plurality of websites, etc.

It is an advantage of embodiments according to the present invention that object prioritization can be performed in a network according to the specific relatedness to user-provided context, typically provided as at least one source object in the network. Such at least one source object may be a set or a plurality of source objects.

It is an advantage of embodiments according to the present invention that methods and systems are not based on obtaining a shortest connection path. It is an advantage of some embodiments of the present invention that they can avoid prioritizing generic, unspecific and unrelated nodes for the context, so that objects rather specific for the provided context can be found. It is an advantage of embodiments according to the present invention that these are especially advantageous in databases or networks having small-world properties, i.e., wherein most objects are not directly connected with each other, but are reachable in a small number of steps.

It is an advantage of at least some embodiments according to the present invention that paths can be found between at least one source object and a target object that is a likely path, but is not necessarily the most likely path or the shortest path between the set of one or more source objects and a target object.

It is an advantage of at least some embodiments according to the present invention that, especially in large information databases or networks, a computational workable solution can be obtained.

It is an advantage of embodiments according to the present invention that objects can be found that are specifically related to the context set of one or more source objects, without selecting generic hubs of the network. For example, it is an advantage that people in a social network are found that are tightly linked with a source person, but are not famous people with a large social network who are not specifically linked to the source person; websites that are linked to a set of source websites are found, but not general hubs of the internet; genes specific to a disease are found, while avoiding generic genes that are involved in a range of biomedical processes.

Furthermore, it is an advantage of embodiments of the present invention that hypotheses are found that intelligibly support the proposed prioritizations to assess the quality of the prioritizations. Paths that indirectly and non-obviously link source and target nodes in the graph support the prioritizations of the above methodology, specific to these sources and targets. For example, paths through the social network that link two people are found, while avoiding highly networked people as intermediate steps; interconnecting websites between source and target websites are found that are not hubs of the network of websites; functional hypotheses linking a source disease and target gene are found while avoiding generic biomedical concepts, e.g., avoiding water compound or protein binding annotations in an integrated information system of biomedical information as these are generic and thus unspecific in relating the source and target biomedical concepts.

The above objective is accomplished by a method and device according to the present invention.

The present invention relates to a computer-implemented method for ranking information in an information system comprising linked objects, the method comprising obtaining a prior value for each of a plurality of objects in the linked database, the prior value being indicative of the importance of the object in the linked database, obtaining, i.e., receiving, an input comprising at least one source object, determining a posterior value being indicative of the probability to be reached for each of the plurality of objects using random walk with restart in the at least one source object, and determining a ranking of the plurality of objects in the information system using the determined posterior value and applying a correction factor inversely related with the computed prior value of the objects, and providing an output being a set of objects selected based on the ranking of the plurality of objects in the information system.

Obtaining a prior value may comprise obtaining a prior probability being the probability to be reached for each of a plurality of objects in the linked database using a random walk with random restart operator.

Applying a correction factor inversely related to the obtained prior value of the objects may be weighting with a factor inversely proportional with the obtained prior value of the objects.

Determining a posterior value may comprise taking into account the adjacency of objects in the information system.

The information system may comprise a group of sub-information systems.

The method may comprise applying a user-specific or source object-specific filter.

Applying a filter may be performed on the plurality of objects of the information system used for obtaining a prior value and obtaining a posterior value.

Applying a filter may be performed during or after determining the ranking of the plurality of objects.

The present invention also relates to a system for ranking information in an information system comprising linked objects, the system comprising a prior value-obtaining means for obtaining a prior value for each of a plurality of objects in the linked database, the prior value being indicative of the importance of the object in the linked database, an input means for obtaining an input comprising at least one source object, a posterior value-detelmining means for determining a posterior value being indicative of the probability to be reached for each of the plurality of objects using random walk with restart in the at least one source object, a ranking means for determining a ranking of the plurality of objects in the information system using the determined posterior value and applying a correction factor inversely related with the computed prior value of the objects, and an output means for providing an output being one or more objects selected based on the ranking of the plurality of objects in the information system.

The prior value-obtaining means may comprise a prior probability-obtaining means being a means for obtaining a prior probability, the prior probability being indicative of a probability to be reached for each of a plurality of objects in the linked database using a random walk with random restart operator.

The system furthermore may comprise a filtering means for filtering the plurality of objects or the ranking of the plurality of objects.

The present invention also relates to a computer-implemented method for obtaining information from an information system, the method comprising obtaining an input comprising at least one source object, and obtaining a ranking of a plurality of objects in the information system, the obtained ranking being determined using a method for ranking as described above.

The present invention furthermore relates to a computer program product for performing, when executed on a computing device, ranking information in an information system according to any of the methods for ranking as described above. The computer program product may be a web application.

The present invention also relates to a web application for performing a method of ranking information as described above.

The present invention also relates to a machine-readable data storage device storing such a computer program product and/or to the transmission of such a computer program product over a local or wide area telecommunications network.

The present invention also relates to a computer-implemented method for determining at least one probable path between at least one source object and a target object in an information system comprising linked data objects, the method comprising obtaining an input comprising a target object and at least one source object, obtaining a posterior value for objects in the information system being indicative of a probability of reaching an object in the information system by random walk with restart in the at least one source object, backtracking from the target object to the at least one source object guided by objects on the path having a higher posterior value than objects already present upstream the path from target object toward the at least one source object, and providing an output comprising the at least one probable path based on the backtracking.

Backtracking may comprise declaring the target object as the last object in a current partial path, for each current partial path, determining new partial paths by adding objects to the current partial path, the objects having a higher probability to be reached by random walk with restart in the source than the objects already present in the current partial path, and limiting the total number of new partial paths from the target object toward the at least one source object based on the probability to follow the new partial paths, and until a set of paths is obtained reaching from target object to the at least one source object, declaring the limited number of new partial paths as current partial paths, and repeating the determining and limiting steps described above.

For limiting the total number of new partial paths, the probability to follow a new partial path may be determined by the probability to arrive at the last added object in this partial path based on random walk with restart in the at least one source object combined with the probability of following this partial path based on random walk from this last added object to the target object.

Obtaining a target object may comprise performing a method for ranking a plurality of objects in an information system as described above.

The method may be adapted for being operated in an information system comprising a group of sub-information systems.

The present invention also relates to a system for determining at least one probable path between at least one source object and a target object in an information system comprising linked data objects, the system comprising an input means for obtaining an input comprising a target object and at least one source object, a posterior probability-obtaining means for obtaining a posterior value for objects in the information system being indicative of a probability of reaching an object in the information system by random walk with restart in the at least one source object, a backtracking means for backtracking from the target object to the at least one source object guided by objects on the path having a higher posterior probability than objects already present upstream the path from target object toward the at least one source object, and an output means for providing an output comprising the at least one probable path based on the backtracking.

The backtracking means may comprise a declaring means for declaring the target object as last object in a current partial path, a partial path-determining means programmed for determining, for each current partial path, new partial paths by adding objects to the current partial path, the objects having a higher probability to be reached by random walk with restart in the source than the objects already present in the current partial path, a limiting means programmed for limiting the total number of new partial paths from the target object toward the at least one source object based on the probability to follow the new partial paths, and the system being programmed for, until a set of paths is obtained reaching from target object to the at least one source object, using the declaring means for declaring the limited number of new partial paths as current partial paths, and repetitively using the determining means and limiting means as described above.

The present invention also relates to a method for obtaining at least one probable path from at least one source object to a target object, the method comprising providing at least one source object and obtaining at least one probable path from the at least one source object to a target object, the at least one obtained probable path being determined using a method for determining at least one probable path as described above.

The present invention also relates to a computer program product for performing, when executed on a computing device, obtaining at least one probable path according to a method for determining a probable path as described above. The computer program product may be a web application.

The present invention furthermore relates to a web application for performing a method for determining a probable path as described above.

The present invention furthermore relates to a machine-readable data storage device storing such a computer program product or for transmission of such a computer program product over a local or wide area telecommunications network.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows a flowchart of an example of a prioritization method according to an embodiment of the present invention.

FIG. 2 shows a schematic overview of a system for prioritization according to an embodiment of the present invention.

FIG. 3 shows a flowchart of an example of a method for determining a probable path between at least one source object and a target object, according to an embodiment of the present invention.

FIG. 4 shows an implementation of an algorithm for backtracking according to a method for backtracking of an embodiment of the present invention.

FIG. 5 shows a flowchart of an example of a backtracking heuristic for determining probable paths between at least one source object and a target object according to an embodiment of the present invention.

FIG. 6 illustrates a schematic overview of a system for determining a probable path between at least one source object and a target object, according to an embodiment of the present invention.

FIG. 7 illustrates an example of a computing system as can be used for performing a method for prioritizing and/or determining one or more highly probable paths between at least one source object and a target object, according to an embodiment of the present invention.

FIG. 8 indicates a set of probable paths on how The Stooges are connected to MC5, as can be obtained using a method or system according to an embodiment of the present invention.

FIG. 9 indicates the probable paths regarding the connection between Frédérique Chopin and Felix Mendlssohn, as can be obtained using a method according to the present invention.

Table 1 illustrates the top twenty genes related to Schizophrenia as derived using a system according to an embodiment of the present invention.

Table 2 illustrates the ten most important bands in the last.fm network, as obtained using a system according to an embodiment of the present invention.

Table 3 illustrates the results for a prioritization query for the ten most related artists for The Stooges, according to a pure random walk with restart- (RWR-) based approach (left) and according to a system according to an embodiment of the present invention (right).

Table 4 illustrates the results for a prioritization query for the ten most related artists for Frédérique Chopin, according to a pure RWR-based approach (left) and according to a system according to an embodiment of the present invention (right).

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION

The present invention will be described with respect to particular embodiments and with reference to certain drawings but the invention is not limited thereto but only by the claims. Furthermore, the terms “first,” “second,” “third,” and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. It is to be noticed that the term “comprising” used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of examples of embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The following terms are provided solely to aid in the understanding of the invention. These definitions should not be construed to have a scope less than understood by a person of ordinary skill in the art. Where reference is made to “information system” or “database” or “graph” or “network” in embodiments of the present invention, reference is made to the combination of a plurality of pieces of information and, where present, their links to each other. The terms “information system” or “database” or “graph” or “network” may be used as alternative terminology referring to the same object. Where reference is made to “information system” or “database” or “graph” or “network,” reference may be made to one information system or database or graph or network, or to a combined plurality of information systems or databases or graphs or networks, combined such that at least for one piece of information from one information system or database or graph or network, a link exists to another information system or database or graph or network.

Where reference is made to an object or node of an information system in embodiments of the present invention, reference is made to a piece of information in the information system or database or graph or network. In embodiments of the present invention, the terminology “entity,” “concept,” “document,” “object,” “data,” “data object” or “node” can be used to refer to such a piece of information.

Where reference is made to a link or relation or connection or edge between pieces of information in embodiments of the present invention, reference may be made to any type of relation between pieces of information such as, for example, to citation of one piece of information in another piece of information, occurrence of two pieces of information in a same context, e.g., in a same document in a database, etc.

Where reference is made to a limit distribution in a Markov chain in embodiments of the present invention, thereby is a distribution over all objects whereby for a state-changing step according to the Markov process made from an object chosen according to the distribution, the same distribution over the objects is obtained.

Where reference is made to a neighbor in embodiments of the present invention, reference is made to an object in the environment of a predetermined object that can be reached from the predetermined object in a single step, independent of the direction of the link. It is an advantage of some embodiments that the neighbor may be an in-link or an out-link, an in-link being a neighbor having a direct link toward the object considered, an out-link being a neighbor having a direct link from the object considered.

In embodiments according to the present invention, reference may be made to at least one source object, an initial set of nodes, a set or a plurality of source nodes, a contextual set of source nodes or a context, all referring to the piece or pieces of information in the information system or database identified as the initial set of information for which a user wants to obtain related information in the information system or database. Where reference is made to at least one source object in embodiments of the present invention, reference also may be made to a distribution over the source objects, in case a plurality of source objects is present. In embodiments of the present invention, the at least one source object may be user-defined, computer-defined, experimentally derived, etc.

Where reference is made to “likely path” in embodiments of the present invention, reference may be made to a path from source object to target object that is followed at least once when a substantial amount of random walks is performed. The probability for a path P={s, intermediate₁, . . . , intermediateₙ, t}, where s is the start node and t the end node of the path, is formalized by the following equation: Pr(P, s, t)=1/(#neighbors(s) Π_{i=1 . . . n} #neighbors(intermediateᵢ)) where #neighbors(x) denotes the number of nodes in the information system that are linked from node x.

The present invention will be further described, by way of illustration, with reference to a number of aspects and embodiments according to the present invention.

In a first aspect, the present invention relates to a computer-implemented method for ranking information in an information system comprising linked objects. The method can be applied to any type of information systems comprising linked data objects, such as, for example, social networks linking different contacts with each other, databases comprising a plurality of documents describing one or more pieces of information, databases comprising a plurality of hyperlinks such as the world wide web, databases comprising biomedical relations, etc. For example, embodiments of the present invention could be used for finding related people in a person's social network, recommended websites with respect to a set of user-specified websites, potential susceptibility genes related to a disease in a biomedical information system, etc. Although not being limited thereto, embodiments of the present invention can especially be useful with large information systems, e.g., information systems existing of a plurality of separate information systems combined with each other, i.e., linked with each other through at least one object. Objects in the information system may be objects of different semantic level.

Embodiments of the present invention comprise obtaining a prior value being indicative of the importance of the object in the linked database. Obtaining a prior value may, for example, be obtaining a prior ranking of all objects in the information system. Obtaining a prior value may make use of techniques for identifying the importance, relevance, centrality or influence of objects. Such techniques may, for example, be techniques making use of centrality, such as making use of the degree of a node, making use of the eigenvalue of the graph, making use of cluster coefficients, techniques based on random walk with uniform at random restart over all nodes in the graph, equivalent PageRank algorithms, equivalent random walk with damping factor, or random walk. In some embodiments, the prior value may be a prior probability, i.e., the probability for a node to be reached, e.g., using random walk with random restart. Obtaining a prior value thereby means obtaining a value indicative of the importance of the object in the graph independent of the at least one initial source object.

The method also comprises obtaining, i.e., receiving, an input comprising at least one source object. The at least one source object typically may be a user-defined source object, although embodiments of the present invention are not limited thereto. It may be a set of source objects and also may be referred to as at least one initial object.

The method also comprises determining the probability of reaching an object taking a step in random walk with restart in the at least one source object based on the adjacency between objects in the information system. Two objects thereby may be considered adjacent if a direct link exists between the two objects, i.e., if two objects are linked to each other without another object being in between.

The method also comprises determining a ranking of objects in the information system using the determined probability and applying a correction factor inversely related, e.g., inversely proportional, with the prior value, in one embodiment, for example, with the accessibility of the objects based on the obtained prior value of objects. The accessibility of an object based on the obtained prior value thereby is, or is proportional to, the a priori probability of reaching an object in the information system based on a random walk with random restart operator. The ranking method, also referred to as method of prioritization, according to embodiments of the present invention, thus still is based on this posterior vicinity of the target nodes to the source nodes, but it uses a correction for the node's prior value indicative of importance in the information system, which results in far superior ranking results delivering highly ranked nodes specific to the source nodes, while avoiding generic nodes. In this way, the small-world property of the network can be taken into account. If, for example, two objects v and w are considered in a graph, where the prior authoritative values of these objects equals, respectively, 0.1 and 0.6. Given at least one initial source object S, suppose that the authoritative value, e.g., the a posteriori probability for reaching the object, of the object with respect to S equals 0.2 for object v and 0.3 for object w, then, in the traditional setting, w will be considered more relevant to S than v, as only the a posteriori probability is taken into account. However, it is clear that the at least one source object of S actually decreases the authoritative value of w. The present invention adjusts the ranking such that both the prior authoritative value, for example, the a priori probability of a node to be reached, as the posterior authoritative value are taken into account, and more particularly in such a way that more generic objects are avoided or at least marked as less relevant.

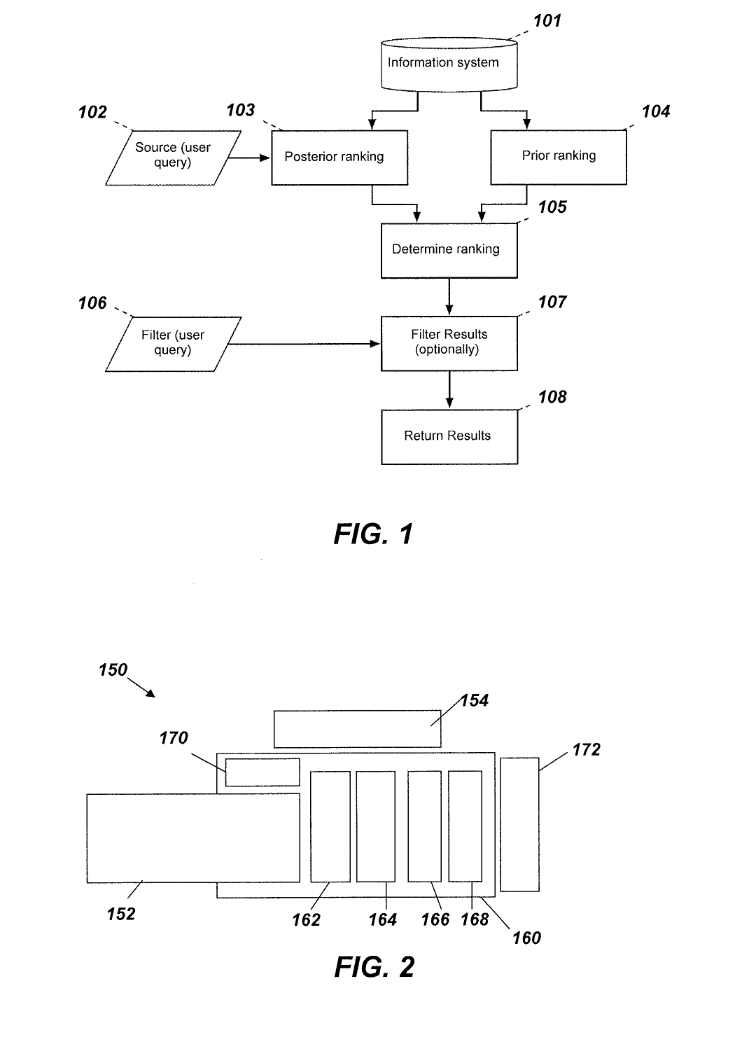

By way of illustration, embodiments of the present invention not being limited thereto, an exemplary method according to one embodiment of the present invention will now be described in more detail, also with reference to FIG. 1, the description providing standard and optional features and advantages for some embodiments of the present invention.

The method is applied to an information system 101 comprising linked objects as described above. The method can be applied to all suitable information systems, such as, for example, directed or indirected graphs. The information system advantageously is strongly connected, and aperiodic. An information system being strongly connected thereby may be defined as an information system wherein, between each two objects, at least one path exists. Such a path may be a direct connection or indirect connection. A direct connection thereby provides a path between two objects, without the need for intermediate objects, while an indirect connection provides a sequence of objects including intermediate objects, the objects in the sequence being connected through edges. An information system being aperiodic is an information system wherein the greatest common divisor of all possible path lengths equals 1 for each pair of start and end nodes.

The method thus may comprise obtaining such an information system, getting access to such an information system, having such an information system stored, etc. In other words, the data in the information system is, in one way or another, available for the method. In one representation, such an information system 101 can be represented as a graph G comprising N nodes, whereby each node i with 1≦i≦N denotes a unique object in the information system. Directed or undirected connections thereby denote links, relations or annotated relations among two objects. The information system 101 may comprise a plurality of information databases and combination of such databases can be performed in steps prior to the current method.

In a first step, the method comprises obtaining a prior value indicative of the importance of the object in the graph independent of an initial source object. In the present example, by way of illustration, the prior value is indicative of a probability of an object in the information system for being reached, using random walk with random restart over all objects, but it is clear as indicated above that embodiments of the present invention are not limited thereto. When reference is made to all objects in the information system, reference may be made to all objects of the information one is interested in or one has or wants access to. For example, a filter may be applied restricting all objects of the information system to that part a user is allowed to have access. Obtaining a prior value of all objects may, for example, be performed by computing, at the time of executing the method, the prior value of all objects or it may, for example, comprise receiving data from a stored prior ranking of all objects in the information system. The prior value thus may be present, e.g., in a stored format, upfront and obtaining then may comprise retrieving the stored information for use. In the following, an example for computing a prior value being a prior probability and a corresponding prior ranking is described in more detail. The information system 101, or the graph representing it, can be represented as an N×N adjacency matrix M, expressing the links between objects. In one embodiment of the invention where the network is a directed graph, element M_{i,j} is 1 if object i is linked from object j, and 0 otherwise. In embodiments of the invention where the network is an undirected graph, elements M_{i,j} and M_{j,i} are both 1 if there is a relation between i and j and 0 otherwise, i.e., one can represent an undirected graph as a directed graph by replacing undirected edges by two directed edges. In other embodiments of the invention, links or relations may be weighted where element M_{i,j} is set to the weight of the link from j to i and 0 if there is no link.

Provided with the adjacency matrix M, one can compute a prior probability 104 and corresponding prior ranking of all objects in the graph according to random walks with random restarts. The number of random walks and random restarts required depends on the dataset, the required precision, the degree of convergence and the particular technique used for determining prior probability. One known algorithm allowing such a prior ranking is the PageRank algorithm as described in U.S. Pat. No. 6,285,999. First, the network's modified adjacency matrix M′ is constructed. The network's modified adjacency matrix represents the probabilities of taking a step in the random walk with restarts, based on adjacency matrix M. To obtain M′, one multiplies each element with a damping factor c and then adds (1−c)/N to each element in the matrix, where the damping factor c is between 0 and 1 (0<c≦1), representing the probability not to restart the random walk at each step, which is commonly chosen between 0.75 (25% chance of restarting the random walk) and 1 (never restarting the random walk). Finally, one linearly scales the elements of the modified adjacency matrix M′ such that each column sum of the matrix equals 1.

This results in a stochastic transition probability matrix M′, which represents the Markov chain of a random walk on the graph G, with probability (1−c) at any step of the random walk to restart the random walk at a random node of the graph. Each element M′_{i,j} now represents the probability to visit object i in the next step if the current state of the random walk is object j. One can, in an example of an embodiment, approximate the limit distribution of the Markov chain by employing the Power Method, as described by Del Corso et al., in SIAM J. Matrix Anal. & Appl.18 (1997), which computes v*=M′ⁿv for any initial probability distribution v over the N states or objects in the network, with n approaching infinity. If the damping follows 0<c<1, the algorithm is guaranteed to be ergodic, i.e., the limit distribution of the random walk process is not sensitive to initial conditions, and the Power Method will consequently converge, following the Perron-Frobenius theorem. In the case that the damping factor c equals 1, convergence is guaranteed only if the network is irreducible and aperiodic, or ergodic, following the Perron-Frobenius theorem. In practice, one iterates the matrix-vector multiplication until numerical conversion of the vector is detected. The resulting vector v* approximates the distribution of probabilities for all nodes with v*ᵢ denoting the probability to visit node or object i during the random walk with restarts in random nodes according to damping factor c. Alternative methods for determining the limit distribution in a Markov chain can also be used. Embodiments of the invention may adopt, for example, other eigenvalue algorithms to determine approximations of the limit distribution of the Markov chain, such as the QR decomposition algorithm, inverse iteration power method, Rayleigh quotient inverse iteration, Arnoldi iteration, Lanczos algorithm, Jacobi eigenvalue algorithm, or the divide-and-conquer algorithm in the case of an undirected graph.

Reference is made to these probabilities as the prior probabilities of the objects in the network. Hub nodes of the network can be identified by their high prior value compared to nodes that are scarcely connected to the graph. This prior value can later be used as a penalty for finding nodes specific to a context. With respect to the example given, when using the term “prior probability” in embodiments of the present invention, reference is made to the probability to visit node or object during the random walk with restarts in random nodes, i.e., without reference to a set of initial nodes or source nodes from which a user wants to start. Nodes having a high prior probability are, in the present example, ranked higher than nodes with a lower prior probability. As indicated above, whereas a particular example has been described for deriving prior value, i.e., through prior probability, also other, alternative processes or prior values could be used.

In another step, a posterior value indicative of the posterior probability is determined 103 and, optionally, a posterior ranking is determined, the posterior probability corresponding with the probability of an object to be reached based on a random walk with restart at a distribution over the at least one source object. The method, therefore, comprises obtaining at least one source object and using the obtained at least one source object for determining the posterior value. Obtaining the at least one source object may be based on a user input received in the processor via a processing means. According to a user query 102 that constitutes at least one source object in the network, e.g., a set of initial objects provided by input, e.g., by the user, one thus computes the posterior value 103 of all nodes in the network using the limit distribution of a random walk with restarts according to a user-provided distribution over the at least one source node. If a distribution over a plurality of source objects is considered, the distribution can be either uniform or can be non-uniform, non-uniform thereby meaning that a larger weight can be given to some source objects, as will be described later.

To determine the posterior value 103 and, optionally, the corresponding posterior ranking, use is made of the adjacency matrix M and a set S with n source nodes that represents the context for which related nodes in the network should be identified. One then can construct the network's modified adjacency matrix M″ that represents the probabilities of taking a step in the random walk with restarts in the set of source nodes, based on adjacency matrix M, in similarity to the construction of M′. To obtain M″, one can multiply each element with d and then add (1−d)/n to each element in the matrix whose column accession number refers to one of the n source nodes, where d is the damping factor with 0<d≦1, representing the probability not to restart the random walk at each step, which commonly, but not necessarily, is chosen equal to the above damping factor of the prior probability c. This results in a random walk with random restarts that are uniformly distributed among the at least one source object. Alternatively, for a more general distribution over the at least one source object where D(x) denotes the user-provided probability to restart in node x, D(x)*(1−d) is added to each element in the matrix whose column accession refers to x instead of adding (1−d)/n in the case of a uniform distribution. Finally, one can linearly scale the elements of M″ such that each column sum of the matrix equals 1.

This results in a stochastic transition probability matrix M″, which represents the Markov chain of a random walk on the graph G, with probability (1−d) at any step of the random walk to restart the random walk at one of the nodes in the set of source nodes according to the user-provided distribution over the source nodes. Each element M″_{i,j} now represents the probability to visit node i in the next step if the current state of the random walk is j. One can approximate the limit distribution of the Markov chain by employing the Power Method, which computes v**=M″ⁿv for any initial probability distribution v over the N states or objects in the network, with n approaching infinity. Convergence is guaranteed if the modified adjacency matrix M″ represents an irreducible and aperiodic Markov chain, following the Perron-Frobenius theorem, as above. The resulting vector v** the distribution of probabilities over all nodes with v**ᵢ denoting the probability to visit node or object i during the random walk with restarts in the source nodes. These probabilities are referred to as the posterior probabilities of the objects in the network. Nodes of the network that are in the vicinity of the set of source nodes have a higher posterior probability, and thus are ranked higher than nodes that are more indirectly connected to the source nodes.

It is to be noticed that the order of the steps of deriving the prior value and, optionally, prior ranking and deriving the posterior value and, optionally, the posterior ranking of the objects in the information system can be altered without hampering on the method.

In a next step, a final ranking score for the nodes is determined 105 based on the posterior value of the node for being reached and a correction factor inversely related with the prior value for the node for being reached. Applying a conversion factor inversely related to the prior value, e.g., negatively weighted with the prior probability, may be such that nodes with a higher prior probability receive a weighting factor that is lower than the weighting factor for nodes with a lower prior probability. The negative correction may, e.g., be a weighting inversely proportional with the prior value. In other words, the final ranking score of a node is determined based on the posterior ranking as described above and negatively corrected by the prior value as described above. The resulting ranking orders the nodes according to their decreasing ranking score, resulting in the highest ranked node being most probable of relevance for the at least one initial source object. Negative correction may be performed by a calculation including taking a ratio, making a division, making a subtraction, etc. In one embodiment of the invention, the ranking score of node i is the ratio of prior and posterior scores, v**ᵢ/v*ᵢ. In some embodiments of the invention, the score is defined as a function F(G(v**ᵢ)/H(v*ᵢ)) where each of F, G and H are monotonically increasing functions; e.g., in one embodiment, the score may be determined as the ratio v^{**}ᵢ²/v*ᵢ. This ranking score then can be adopted for ordering objects with respect to their relation to the at least one source object. Objects are ranked by their vicinity to the at least one source object, but general objects are penalized by their prior accessibility in the global network.

Optionally, the user may provide a filter 106 on the ranking (e.g., a list of people, a web search query or a list of potential target genes), such as a limited list of potential target nodes that require prioritization. The ordered nodes from the ranking are filtered according to this filter 107. In embodiments of the running examples, a user of a social network may, for example, only want to rank people from a specific company, a search query may filter documents in a web search or the ranking of a set of possible target genes may be requested in a biomedical discovery application. A filter also may be applied based on accessibility of a user to certain databases.

Finally, the method returns the ranked and ordered results back to the user 108. The latter can be in any suitable way, such as by storing the data or displaying it on a screen or carrier.

Whereas in the above example, the posterior probability and, optionally, corresponding ranking has been performed separately from the negative correction step, the latter also could be performed in a single step, whereafter ranking could be performed.

The processing according to embodiments of the present invention typically may be performed in an automated and/or automatic way. The method typically may be implemented as a computer-implemented method. Such a method may be performed according to a predetermined algorithm or set of instructions. The method may be performed on a central processor or it may be performed using distributed processing on different processors. In the latter case, the distributed processing may be performed for different parts of the information system, or different processing steps may be performed by different processors. The method also may comprise further optional features as known by the person skilled in the art, such as, for example, obtaining a user identification and applying a filter based on the identified user, storing profiles of users, storing earlier determined rankings and its intermediate results for a predetermined set of initial objects that is often used, etc.

In one aspect, the present invention relates to a system for prioritizing objects in an information system for their relevance to at least one source object of the information system. The system may be especially suitable for use with a method as described in the first aspect of the present invention. The system 150 comprises or can communicate with an information system 152. The information system 152 may be one or a combination of a plurality of databases. The system also may comprise an input means 154 for receiving at least one initial object, e.g., a set of initial objects. The system furthermore comprises a processor, whereby the processor 160 comprises a prior probability processor 162 programmed for obtaining, e.g., from a memory or by calculation, based on the data received from the information system 152, a prior value indicative of an importance of nodes of the information system, independent of identified source objects. In one embodiment, the prior value may be a prior probability for nodes of the information system to be reached using a random walk with random restart in the nodes of the information system. The processor 160 furthermore comprises a posterior probability processor 164 programmed for determining a posterior probability for nodes of the information system using a random walk with restart in the at least one source object. The processor 160 also comprises a ranking processor 166 programmed for ranking the nodes of the information system using the posterior probability of the nodes and negatively weighting or correcting with the prior value of the nodes. The system 150 also may comprise a storage means 170 also referred to as memory for storing data temporary or permanently. The latter may, for example, include the information system 152, although the information system 152 may also be a separate memory. The storage means 170 may be adapted for storing data received from the input means 154, such as, for example, the at least one source object or identification thereof, user supplied information, a user profile, etc. The system 150 also may comprise a filtering means for filtering the output data or intermediate data based on a filter characteristic such as a limitation of the number or type of objects of the information system used for the method, a limitation of the databases used in case the information system is a set of linked databases, etc. The system 150 also may comprise an output means 172 for outputting the obtained prioritization or results thereof, such as, for example, the objects most relevant for the source data provided by the user. The output means may in some embodiments be a memory, a display, a printer, a plotter, etc. Further features may be components programmed or adapted for performing one or more of the optional steps of the method for prioritizing as described in the first aspect.

In a third aspect, embodiments of the present invention relate to a computer-implemented method for determining at least one probable path between a target object and the at least one source object. The method can advantageously be used for determining a set of most likely paths between the at least one source object and a target object. It is an advantage of embodiments according to the present invention that information is provided regarding how the at least one source object to a target object is related. According to embodiments of the present invention, the method comprises obtaining a target object and at least one source object. The target object may be user-defined, although it also may be determined using a method for prioritizing according to the first aspect.

The method furthermore comprises obtaining a probability for reaching objects in the information system by random walk with restart in the at least one source object, such probability also being referred to as posterior probability. The posterior probability can, for example, be previously determined in the method of the first aspect of the present invention and retrieved or can be determined by calculation.

The method furthermore comprises backtracking at least one path from the target object to the at least one source object guided by objects having a higher probability to be reached by random walk with restart in the at least one source object than the objects upstream that path from target object to the at least one source object. Objects upstream the path from target object to the at least one source object thereby means objects closer to the target object when following the path than the object under consideration. The backtracking may thus comprise building at least one path from the target object to the at least one source object through selection, during construction of at least one backtracked path, of further objects for the backtracked path having a higher probability to be reached by random walk with restart in the at least one source object than the current objects already present in the path under construction. The backtracking may comprise declaring the target object as last object in the partial path and, for each of the current partial paths, determining new partial paths by adding to the current partial path objects that have a higher probability to be reached by random walk with restart in the at least one source object than the objects already in the current partial path. The total number of new partial paths from the target object toward the at least one source object thereby may be limited based on the probability to follow the new partial paths, the probability to follow a partial path being determined by the probability to arrive at the last added object in this partial path based on random walk with restart in the at least one source object combined with the probability of following this partial path based on random walk from this last added object to the target object. The steps of determining new partial paths and limiting the total number of new partial paths are repeated until a set of paths is obtained reaching from target object to the at least one source object. In some examples, the paths found may identify intermediate contacts between people in a social network, linking web documents between a set of source documents and a target document, or for identifying indirect and non-obvious functional hypotheses linking target genes to a disease. The resulting probable path typically is provided as output. In other words, it is an advantage of embodiments according to the present invention that information regarding the possible functional relationships between target object and the at least one source object could be obtained.

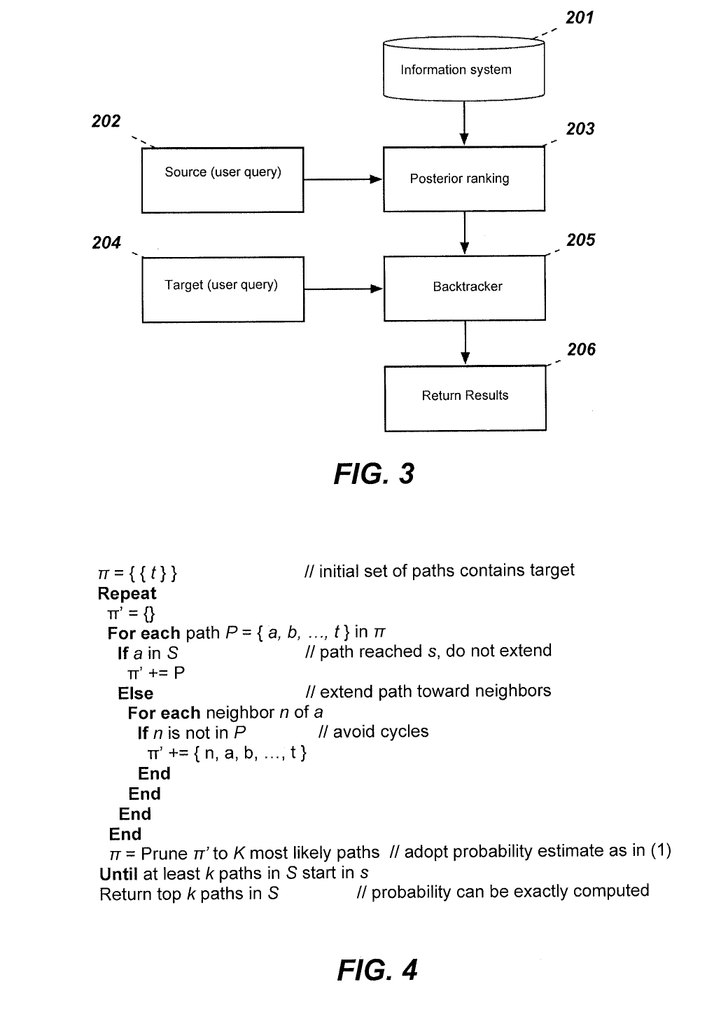

By way of illustration, embodiments of the present invention not being limited thereto, an exemplary method according to one embodiment of the present invention will now be described in more detail, also with reference to FIG. 3, the description providing standard and optional features and advantages for some embodiments of the present invention.

The exemplary method described below provides at least one, and preferably a set of, paths between at least one source object and a target object. In order to enumerate the k most likely paths, a heuristic is used in the following example. This heuristic uses a parameter K, with k<<K<<N, such that there are never more than K partial paths under consideration. Although the worst case computational complexity is O(KN), the expected computational complexity is O(K). This expected computational complexity holds when the algorithm is conducted on a network that inhibits small-world properties. In this case, the following two observations hold: 1) a majority of the nodes can be reached from another node in a small number of steps, and 2) the definition of “most likely path” favors shorter paths. The derived expected computational complexity follows directly from these observations.

The exemplary method comprises obtaining a target object and at least one source object. The at least one source object can be received from the user using an input means. The target object can be obtained as input from the user. Alternatively, the target object can be obtained using a method for ranking objects in an information system as described above. Such a method can provide a set of objects that are most probably relevant for the at least one source object defined, and one or more of the objects found using the method may be used as input for the present method for determining a probable path. The probable path may be a highly likely path of the random walk between the at least one source object and the target object, specific to these source and target nodes. The resulting paths are specific to the source and target nodes in that these paths avoid hub nodes to find indirect links between the nodes. In one particular embodiment of the present example, the method enables finding paths between any set of source nodes and a target node without requiring the prioritization of targets with respect to a context.

In a further step, based on the information system 201 and a user's query 202 comprising the at least one source object, a posterior probability 203 is obtained. The posterior probability is used to describe the probability that an object is visited based on random walk with restart in the at least one source object, a posterior ranking may be a ranking based on the posterior probability. Obtaining such a posterior probability and, optionally, a posterior ranking, can be performed as described in the method of the first aspect. Alternatively, it can be obtained based on the ranking method optionally performed in the previous step, for which such posterior probability already may be determined.

The method further comprises backtracking from the target object to the at least one source object, the backtracking being guided by objects on the path having a higher posterior probability than objects already present upstream, the path from target object toward the at least one source object. In other words, the method is based on estimating probabilities to traverse the graph adopting the posterior probabilities of each object in the network with respect to the at least one source object to guide the backtracking heuristic from the target object toward the at least one source object. The backtracking may be based on a heuristic. Provided with the target node in the network 204, a backtracking heuristic 205 can be run to detect paths between the set of source nodes and the target node. The method can then return the results, as a set of paths from the source nodes to the target node back to the user in a subsequent step 206. The heuristic method for the identification of paths thus identifies k highly probable paths of the random walk from the at least one source object to the target object by adopting a backtracking algorithm, i.e., starting from the target node to find highly probable paths going backward toward the source nodes, guided by nodes that are more accessible from the source nodes than the current node.

An example of how the backtracking may be performed is further described in more detail below: Assume a set of source nodes S with at least one source node and a target node t in the integrated network. Let a simple path P between a source node s in S and target node t be defined as an ordered list

P={s, intermediate₁, . . . , intermediateₙ, t}

where each node in the list is unique and there exists an edge in the network for each of the consecutive steps, i.e., (s, intermediate₁), (intermediate₁, intermediate₂), . . . , (intermediateₙ, t) are all edges of the network. The probability of a random walker to traverse this path, provided it starts in a node s (chosen uniformly from S) and ends in t equals

1/(|S| #neighbors(s) Π_{i=1 . . . n} #neighbors(intermediateᵢ))

where #neighbors(i) denotes the number of neighbors of node i in the network.

In order to find highly probable paths leading from nodes in S to t, one finds the most accessible neighbor objects, starting backward from t with respect to s, moving toward s. At each iteration of the heuristic, one expands the set of neighbors backward to the at least one source object and prunes the set of generated partial paths—with respect to the probability of following this path in a random walk—to a workable number K (sufficiently larger than k). Eventually, this set of highly accessible paths traces back to the at least one source object, thus generating a set of highly likely functional paths grounding the indirect relation between the source and target objects.

More specifically, consider a partial path P′ in the backtracking algorithm with some intermediate objects and the target objects t, as follows

P′={intermediate₁, intermediate₂, . . . , t}.

One can estimate the probability to follow this partial path in a random walk from s to t by considering the posterior probability to arrive at the first intermediate object of this path with respect to the at least one source object s, and by computing the probability for a random walk to follow the path under construction from this first intermediate object onward to reach the target t, which is defined as

Pr(P′,St)≈posterior(intermediate₁|S)/Π_{i=1 . . . #intermediates} #neighbors(intermediateᵢ)

where posterior(i|S) denotes the posterior probability v**ᵢ to visit node i for the set of source nodes S, as defined above.

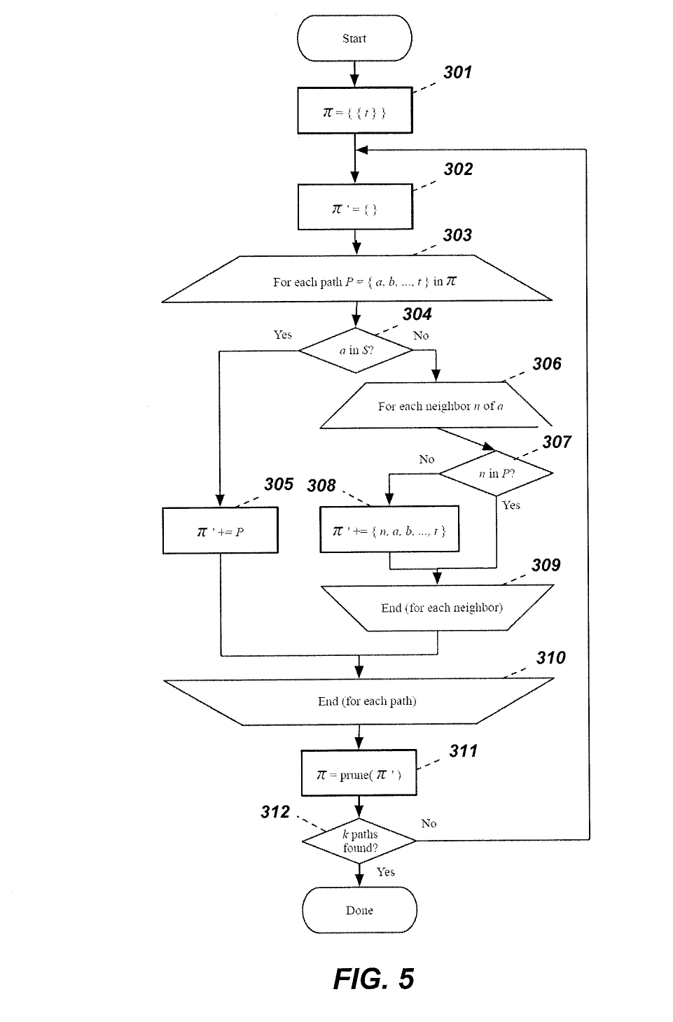

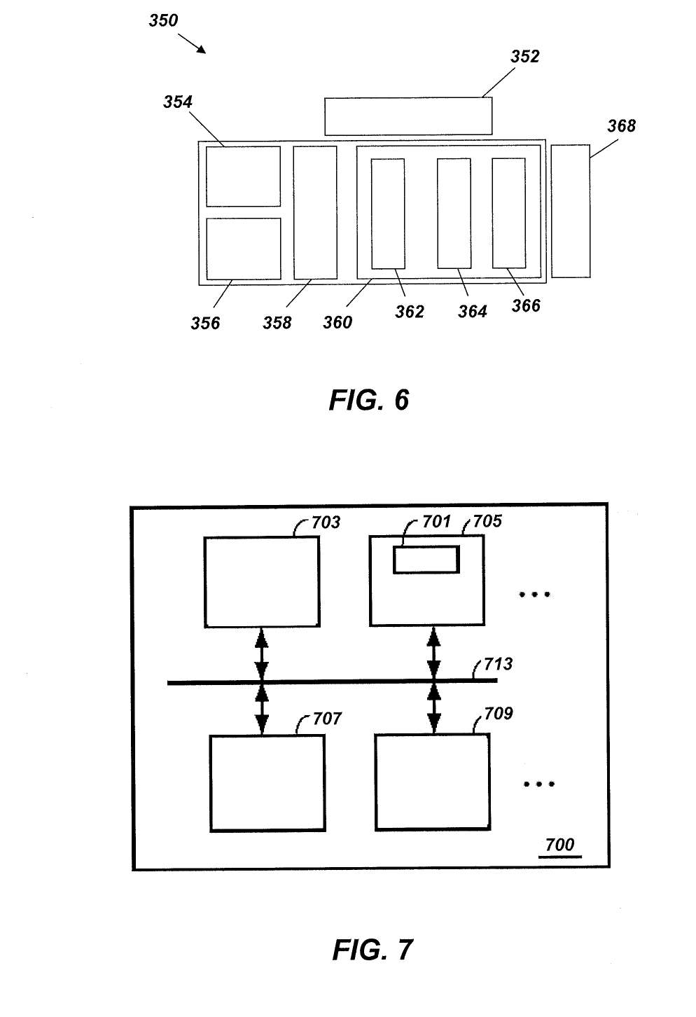

By way of illustration, an algorithm for backtracking paths, to find k paths from s to t by backtracking the paths from target t and by pruning this set to K (>>k) paths at each iteration, is also shown in FIG. 4, illustrating pseudo code for performing such backtracking. The pseudo code for performing the backtracking is schematically shown in the flow chart of FIG. 5.

At each iteration of the algorithm, one starts with a set π of partial paths, extend this set of paths by prepending neighbors to each one of the paths and prune this new set such that only the most likely paths according to the estimation as above remain. Initially, the set of partial paths π contains one partial path, which only has the target object, i.e., π={{t}} 301.

At each iteration of the backtracking algorithm, a new, empty set of partial paths π′ 302 is started.

Each partial path P={a, b, . . . , t} in π 303-310 is considered. If this partial path P's first element is an element of the set S of sources 304, this partial path is added in the new set of partial paths π′ 305.

On the other hand, if the path P does not start in an element of set S 304, this path is extended to all of the first element in the path's neighbors and add these extended partial paths to π′. More specifically, if node a is the first element in path P, each neighboring node n of node a in the network 306-309 is considered. In one embodiment of the invention where the graph is undirected, one considers each node n as a neighbor of a if there is an edge between node n and a. In an embodiment of the invention with a directed graph, one considers each node n as a neighbor of a if there exists a directed edge from n to a. If a neighboring node n is not already in partial path P 307, one adds the extended path P′={n, a, b, . . . , t} to π′ 308. Otherwise, if the neighboring node n is already in the partial path 307, one does not extend the path to this neighboring node.

At the end of each iteration, one prunes the new set of partial paths π′ such that its K most probable paths remain and replace r with this pruned set 311. More specifically, one computes the estimated probability Pr(P, S, t) of all partial paths P in π, with respect to the set S of source nodes and target node t, and keep the (at most) K most likely paths as the new set of partial paths π.

If the resulting set of partial paths it contains at least k paths that start in a source node of set S 312, then the k most likely paths are reported as the result of the heuristic. If there are fewer than k paths in π, one starts a new iteration of the heuristic 302.

In a fourth aspect, the present invention relates to a system 350 for determining at least one probable path between a target object and at least one source object. The system comprises an input means 352 for obtaining a target object and at least one source object. In some embodiments according to the present invention, a memory 354 is provided for storing intermediate results, end results or user input. In some embodiments according to the present invention, a processor 356 is also present for deriving a target object using a method for prioritizing according to the first aspect. The system 350 may therefore comprise a prioritization processor 356, which may comprise similar or the same components as these described in the second aspect. The system 350 also comprises a posterior probability processor 358 for obtaining a probability for reaching objects in the information system by random walk with restart in the at least one source object. Alternatively, the posterior probability processor may be replaced by an input means for the posterior probability, which can, e.g., be obtained from a system as described in FIG. 2. The different processing steps and different processors above may be performed as software components or hardware components. These software or hardware components may be performed by a single physical processor or by more separate physical processors. The system 350 furthermore comprises a backtracking means 360 for backtracking at least one path from the target object to the at least one source object guided by objects having a higher probability to be reached by random walk with restart in the at least one source object than the objects upstream that path from target object to the at least one source object.

The backtracking means may comprise a declaring means 362 for declaring the target object as last object in the partial path, a determining means 364 for each of the current partial paths, determining new partial paths by adding to the current partial path objects that have a higher probability to be reached by random walk with restart in the at least one source object than the objects already in the current partial path and a limiting means 366 for limiting the total number of new partial paths from the target object toward the at least one source object based on the probability to follow the new partial paths, the probability to follow a partial path being determined by the probability to arrive at the last added object in this partial path based on random walk with restart in the at least one source object combined with the probability of following this partial path based on random walk from this last added object to the target object. The processor may be adapted for repeating the steps of determining new partial paths and limiting the total number of new partial paths until a set of paths is obtained reaching from target object to the at least one source object. Furthermore, an output means 368 for putting out one or more probable paths from source to target may be provided. Further optional features of the system 350 may be components with the functionality of the steps of the method as described in the third aspect of the present invention.

In one aspect, the present invention also relates to a computer-implemented method for obtaining information from an information system. Such a method comprises providing at least one source object and obtaining a plurality of ranked objects, whereby the objects were ranked using a method according to the first aspect of the present invention or using a system according to the second aspect. In another aspect, the present invention also relates to a method for obtaining information from an information system, wherein the method comprises providing at least one source object and a target object and obtaining at least one path between the target object and the at least one source object, the path being determined using a method according to the third aspect of the present invention or using a system according to the fourth aspect. In still another aspect, the present invention relates to a method for obtaining information, the method comprising providing at least one source object and obtaining a plurality of ranked objects, whereby the objects were ranked using a method according to the first aspect and obtaining at least one path between the at least one source object and at least one of the ranked objects, the at least one path being determined using a method according to the third aspect of the present invention or using a system according to the fourth aspect. In another aspect, the present invention relates to an information processing system for obtaining information from an information system, the information processing system comprising the features of a system according to the second aspect and the features of a system according to the fourth aspect. Processors, input means and output means that are in common may be provided only once in the information processing system.

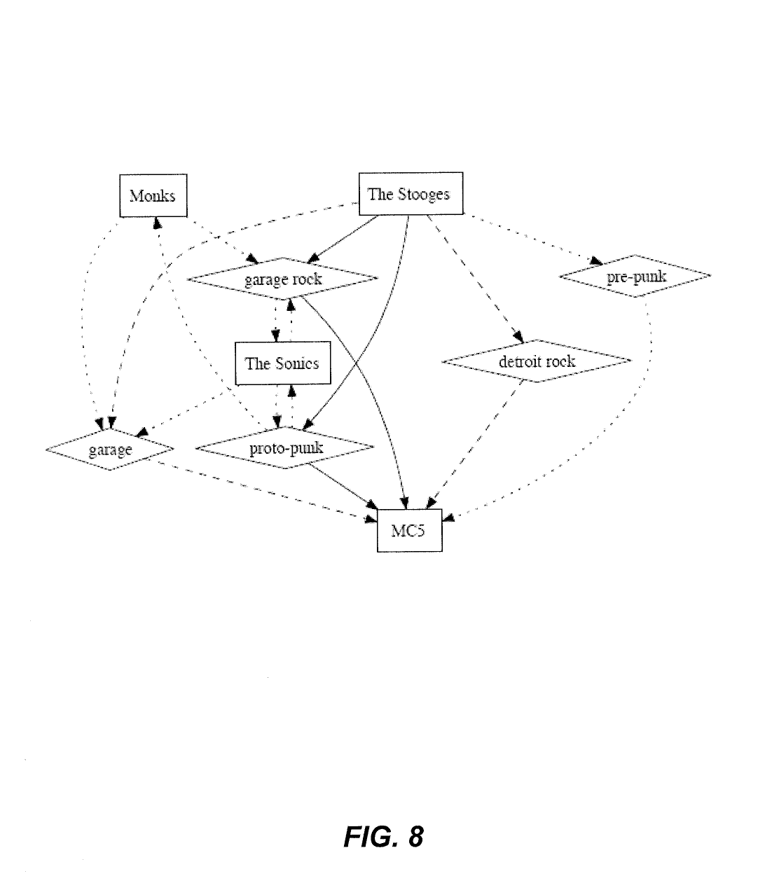

The above-described method embodiments for prioritizing objects in an information system and/or for providing at least one path typically may be at least partly implemented in a processing system 700 such as shown in FIG. 7. Also, the systems as described above may be implemented as a processing system, may be a part thereof or may comprise such system. FIG. 7 shows one configuration of processing system 700 that includes at least one programmable processor 703 coupled to a memory subsystem 705 that includes at least one form of memory, e.g., RAM, ROM, and so forth. It is to be noted that the processor 703 or processors may be a general purpose, or a special purpose processor, and may be for inclusion in a device, e.g., a chip that has other components that perform other functions. Processing may be performed in a distributed processing manner or may be performed at a single processor. Thus, one or more aspects of the present invention can be implemented in digital electronic circuitry, or in computer hardware, firmware, software, or in combinations of them. The different steps may be computer-implemented steps. The processing system may include a storage subsystem 707 that has at least one disk drive and/or CD-ROM drive and/or DVD drive. In some implementations, a display system, a keyboard, and a pointing device may be included as part of a user interface subsystem 709 to provide for a user to manually input information. Ports for inputting and outputting data also may be included. More elements such as network connections, interfaces to various devices, and so forth, may be included, but are not illustrated in FIG. 7. The memory of the memory subsystem 705 may at some time hold part or all (in either case shown as 701) of a set of instructions that, when executed on the processing system 700, implement the steps of the method embodiments described herein. A bus 713 may be provided for connecting the components. Thus, while a processing system 700 such as shown in FIG. 7 is prior art, a system that includes the instructions to implement aspects of the methods for ranking or prioritizing objects in the information system and/or for finding at least one probable path and, therefore, FIG. 7, is not labelled as prior art.

The present invention also includes a computer program product that provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including, but not limited to, non-volatile media, and transmission media. Non-volatile media includes, for example, optical or magnetic disks, such as a storage device that is part of mass storage. Common forms of computer-readable media include a CD-ROM, a DVD, a flexible disk or floppy disk, a tape, a memory chip or cartridge or any other medium from which a computer can read. Various forms of computer-readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fiberoptics, including the wires that comprise a bus within a computer.

In some embodiments, the computer program products or systems as described above may be web applications, also referred to as web services, i.e., computer program applications that can be performed and/or provided using a network, such as, for example, a LAN, a WAN or the Internet. The information system, e.g., a plurality of databases, typically may be located at a place distant from the user. The system and/or method may be provided to a user as a web application, whereby the input is requested via a user interface. The processing may be performed at the user location using information also present at the user location, or may be performed at the user location using information present at one or more locations distant from the user location, or may be performed at a location distant from the user location, or may be performed combining any of these processing methods. The results may be provided to the user. The web application may be using a graphical user interface, although embodiments of the present invention are not limited thereto.

It is to be understood that although preferred embodiments, specific constructions and configurations, as well as materials, have been discussed herein for devices according to the present invention, various changes or modifications in form and detail may be made without departing from the scope and spirit of this invention. Functionality may be added or deleted from the block diagrams and operations may be interchanged among functional blocks. Steps may be added or deleted to methods described within the scope of the present invention.

By way of illustration, embodiments of the present invention not being limited thereby, two particular embodiments are described in detail below, illustrating features and advantages of some embodiments of the present invention.

The first set of examples illustrates the use of methods and systems according to embodiments for the exploration and discovery of biomedical information. Prioritization of putative disease genes is illustrated, supported by functional hypotheses. It is illustrated that the systems and methods retrospectively confirm recently discovered disease genes and identify potential susceptibility genes, outperforming existing technologies, without requiring prior domain knowledge. The database used in the present example is a data integration of 21 publicly available curated databases containing biomedical relations between heterogeneous biomedical entities such as genes, diseases, compounds, pathways, ontology terms, protein domains, disease and gene families, and microRNAs. In order to guarantee the accurateness of the integrated knowledge, the integrated databases were selected based on their curation processes for the indexing of knowledge from the peer-reviewed scientific literature.

With regard to the integration of diverse databases with diverse identifiers for the concepts, each concept is provided with a distinct accession number, based on the Unified Medical Language System (UMLS), to guarantee each concept's uniqueness. Where required, the UMLS identifiers were extended. Relations between concepts were extracted from integrated databases and all relations in the network were equally weighed independent of their support in the databases or the literature. Different weighing relations did not significantly affect test benchmarks. To sanitize the resulting network for the subsequent data mining algorithms, disconnected concepts from the largest connected network were removed and dangling concepts (i.e., concepts connected to only one other concept) were pruned. As a result, the integrated network comprises 54,567 biomedical entities representing unique biomedical concepts and 425,353 unique relations among these entities, supported by 244,258 references to 52,866 items from the biomedical literature. The integrated network was frequently updated with updates of its dependent resources and the list of integrated databases may be appended with additional resources. The system was used in the identification of genes known to be associated with a disease. Test sets of proven disease-related genes were selected from the OMIM MorbidMap and CTD databases.

In a first particular example, the performance of the platform in prioritizing known disease genes among all genes in the integrated knowledge base was tested. For testing a known disease-gene association, first the link and links with related diseases were removed between the disease and its susceptibility gene from the knowledge base. All genes where then ranked in the network in relation to the disease and the ranking of the test gene was evaluated. A comparison was made with Endeavour, a known gene prioritization technology, for benchmarking. For both platforms, the area under the receiver operator characteristic (ROC) curve, i.e., AUC, was determined for analyzing the quality of these prioritizations. Sensitivity and specificity values were computed and the area under the receiver operator characteristic (ROC) curve (AUC) was observed as the standard performance measure for analyzing the quality of prioritizations or classifications. A perfect ranking algorithm that manages to put the true disease genes at the top would score 100% on such a test, where random rankings score 50%. Provided with a reliable and valid AUC measure, it can be interpreted as the probability that when one randomly picks one positive and one negative example, the prioritization algorithm will assign a higher rank to the positive example than to the negative. An algorithm that scores well on this assessment is thus likely to identify disease-associated genes as high-ranking genes and vice versa. The mean AUC for the prioritization of disease genes among all human genes using the system of the present example is 92.92%, where the reported AUC for Endeavour in prioritizing disease genes among 99 random genes is 86.6%. Of 609 disease genes in the benchmark, 181 prioritizations (29.72%) were ranked in the top 1% of the test set of all genes and 449 (73.73%) were ranked in the top 10%. In other words, in an experimental application where a causative gene is among a set of 99 random genes, the system and method of the present example is expected to rank the defecting gene as the top gene in 29.72% of the cases and in the top 10 with probability 73.73%. The benchmark indicates that the prioritization approach yields a considerable improvement over mature technologies. There are two noteworthy differences in the experimental benchmarking design. The platform does not require a training set of known disease-causing genes since it will implicitly base prioritizations on integrated disease-gene associations in addition to other heterogeneous types of integrated knowledge of the disease. This has a major advantage for the user since no prior knowledge of the disease is required. Secondly, the platform provides a ranking of the disease gene in relation to all known genes, where Endeavour ranks disease genes among a random set of 99 non-disease genes.

In a further example, detectability of recently curated additions of human disease—gene relations, which were not present in the database, were evaluated. An AUC value of 86.14% was found for the system of the example. Of 845 curated disease genes, 189 prioritizations (22.73%) are ranked in the top 1% of the test set consisting of all genes for its corresponding disease and 524 (62.01%) are ranked in the top 10%. The median rank of a disease gene is in the top 6.04%. The latter illustrates that the method can be adopted to predict putative susceptibility genes for heritable diseases. Feasible applications of the framework are the identification of functionally interesting genes from sets of candidate genes, for example, in the identification of promising genes in linked regions, copy number variation regions or for the identification of genes through genome-wide association or expression studies. Additionally, the automated construction of hypotheses is of interest to explore genetic/genomic findings in peer-reviewed functional support. Collecting functional support for newly discovered disease-gene associations is not always obvious, especially when the functional evidence is indirect and spans several fields of interest.

With the advent of high-throughput methodologies and torrents of published material to substantiate these findings, detecting relevant information has become a laborious process where computational techniques, such as those presented here, allow for these processes to be automated. Beyond applications in genetics and genomics, the framework can similarly be adopted to prioritize or to determine functional support for biomedical relations other than disease-gene associations, for example, in linking drug compounds, annotation terms, pathways, etc., making the framework a very versatile tool in the discovery of diverse types of biomedical knowledge. In one feasible application, the method can be adopted to determine functional interactions between drug compounds and for the in silico exploration of drug-drug interactions or the prioritization of identifying compounds in screening pipelines. Another example application is the computational inference of clinical biomarkers related to pathways, biochemical functions or disease processes, building on the various integrated types of concepts, relations and integrated literature references to detect promising candidates.

In another example illustrating the possible applications of the methods and systems of the present invention, the system is employed for predicting candidate genes for schizophrenia and substantiate the top predictions with support adopting the automatically generated functional hypotheses. Schizophrenia (SZ) is a common neuropsychiatric genetic disorder with ˜1% prevalence and with 64% heritability. It is characterized by a constellation of symptoms including hallucinations and delusions, and symptoms such as severely inappropriate emotional responses, disordered thinking and concentration, erratic behavior, as well as social and occupational deterioration. The newly identified genes are indirectly inferred from the integrated knowledge, but not directly associated in the gene-disease resource databases. This enabled checking if the predicted genes have been observed in genetic studies, thus enabling cross-check. When queried to infer the top 20 genes that are not already linked to Schizophrenia in this network, the system suggests:

TABLE 1

| No. | Gene |
|---|---|
| 1 | PRL |
| 2 | ARID4B |
| 3 | HTR1A |
| 4 | DRD2 |
| 5 | DNMT3B |
| 6 | DNMT3A |
| 7 | FSTL1 |
| 8 | SYN3 |
| 9 | MYLIP |
| 10 | EFEMP2 |
| 11 | UTRN |
| 12 | OMG |
| 13 | BACE1 |
| 14 | HIPK3 |
| 15 | TAC1 |
| 16 | ATXN1 |
| 17 | SYN1 |
| 18 | RTN4IP1 |
| 19 | CDKN1A |
| 20 | LINGO1 |

Of these top 20 genes, HTR2A, DRD2, DNMT3B, OMG, and ATXN1 have been shown in the literature to be indeed associated with Schizophrenia, with some others showing Schizophrenia-like phenotypes, although information on these associations was not in the network, supporting the correctness of predictions of the claimed system. Additionally, the backtracking heuristic provides functional hypotheses why these genes are possibly related to schizophrenia.

From the present example, it can be understood that the presented methodology is generic and applicable in various fields, such as, for example, also in biological research settings requiring the construction of intelligent and intelligible hypotheses among interrogated concepts. One may use the platform, for example, to identify diseases related to a pathway of interest, or to enrich a priori defined gene sets to determine related ontology terms, compounds or protein domains.

A second particular set of examples illustrates a graph-based music recommendation system in a social bookmarking service, illustrating features and advantages of some embodiments of the present invention. Social bookmarking services have emerged as a valuable tool for collectively organizing online content.

The database information used was retrieved based on the music recommendation service Last.fm, whereby 443,816 names of artists and 127,516 tags describing these artists were used. For every artist, all the user-defined tags that were used to label the artist were retrieved. Moreover, the tags for an artist were normalized and given a weight relative to the most popular tag for the artist. These weights were between 1 and 100 and correspond to the number of (distinct) users that assigned the tag to the artist. In particular, the most popular tag for an artist was assigned the weight 100, and all other tags were weighted in accordance with their frequency relative to the most frequent tag. The same weighting was used for the tag to artist relation. Note, however, that the weight for the artist to tag relation is in general different from the weight for the same reversed relation. This is the case because weights assigned to the tags to artist relation is normalized per tag, while weights for the artist to tag relation are normalized per artist.

A step of data cleaning was performed whereby tags or artists with the same label but difference in capital letters/lowercase letters, punctuation, spacing, etc., are transformed into uniform writing style. This resulted in removing all non-alpha and non-digit characters from the labels, transformed all capital characters into lowercase ones, replaced “&” by “and” and removed the definite article “the” from the beginning of the label. As a result, Beatles and The Beatles are the same, as well as “post-modernism,” “postmodernism” and “post modernism.” The resulting dataset consisted of 109,345 tags and 407,036 artists. Finally, every artist and every tag was mapped to a distinct node in the graph. The weighted directed edges in the graph correspond to the relations from tags to artist and from artists to tags, where the weight of the edge is equal to the respective weight of the relation. Finally, as a last pre-processing step, all nodes were removed that had less than two outlinks in the graph, effectively removing concepts that were badly connected. The resulting graph consisted of 49,022 tags, describing 18,634 artists. In comparison with the original dataset, it is, especially for the number of artists, a huge reduction. The main reason for this is that a lot of artists are simply not tagged.

The first experiment consisted of finding the most important artists in the graph; that is, the artist with the largest eigenvector centrality. The ten most important artists in the last.fm network are displayed in Table 2.

TABLE 2

| | |
|---|---|
| 1 | Radiohead |
| 2 | The Beatles |
| 3 | Muse |
| 4 | The Killers |
| 5 | Bjork |
| 6 | Arcade Fire |
| 7 | David Bowie |
| 8 | Coldplay |
| 9 | The Red Hot Chili Peppers |
| 10 | Pink Floyd |

Remarkable is that most artists can best be described by the genre “alternative rock,” and that today's most popular artists (according to billboards, such as Justin Bieber, Lady Gaga, etc) are missing. Moreover, complete different music styles like classical music or Jazz are also absent in the top ten. However, the most important artists on the last.fm network give an insight of the majority of users on the collaborative music tagging webservice last.fm.

The next experiment consisted of deriving the most related artists for The Stooges, a well known American punk band from the late sixties and early seventies. In this experiment, the results of the recommendation by the system of the present example (right column) with the results from a purely random walk with restarts-based recommendation (left column) are compared. The results are shown in Table 3.

TABLE 3

| | |
|---|---|
| The Beatles | MC5 |
| Radiohead | Modern Lovers |
| Green Day | Iggy Pop & James Williamson |
| David Bowie | Richard Hell and the Voidoids |
| The Rolling Stones | Mink DeVille |
| Muse | Flamin' Groovies |
| The Strokes | The Monks |
| Kings of Leon | ? and the Mysterians |
| The White Stripes | New York Dolls |
| The Killers | The Sonics |

The first remarkable observation is that the results for the RWR approach consist mainly of well-known bands, while the results of the recommendation service consists—except for the connoisseur of this genre—of unknown bands. A related observation is that five out of ten recommendations from the RWR approach belong to the top ten most important nodes in the last.fm network. This observation illustrates the advantage that typically no overly general related results are obtained using the methods of embodiments of the present invention in contrast to a pure RWR-based approach for finding related concepts. Another sanity check to judge the predictions is by examining the most likely paths between The Stooges and the most related prediction MC5 by the system according to an embodiment of the present invention. These ten most likely paths are shown in FIG. 8. From these paths, one can derive that the most influential tags for the prediction are proto-punk and garage rock, which make perfectly sense for The Stooges. Other influential tags are garage and Detroit rock, while pre-punk is the least influential tag. Also, some other top predicted bands are influential for the relation between the two concepts: The Monks and The Sonics, which both have common connections to the tags garage, proto-punk and garage rock.

Another experiment was performed for a complete different music genre. The ten most related artists for the classical composer Frederique Chopin were retrieved, using a method according to an embodiment of the present invention, listed in the right-hand side column of Table 4 and using a random walk with restart (RWR) process known from prior art, listed in the left-hand side of Table 4.

TABLE 4

| | |
|---|---|
| Ludwig Von Beethoven | Felix Mendelssohn |
| Ludovico Einaudi | Gabriel Fauré |
| Philip Glass | Robert Schumann |
| Radiohead | Sir Edward Elgar |
| Erik Satie | Franz Schubert |
| Pyotr Llyich Tchaikovsky | Richard Wagner |
| Claude Debussy | Ron Pope |
| Yann Tiersen | Edvard Grieg |
| Howard Shore | Giuseppe Verdi |
| Antonín Dvo\check{r}ák | Johannes Brahms |

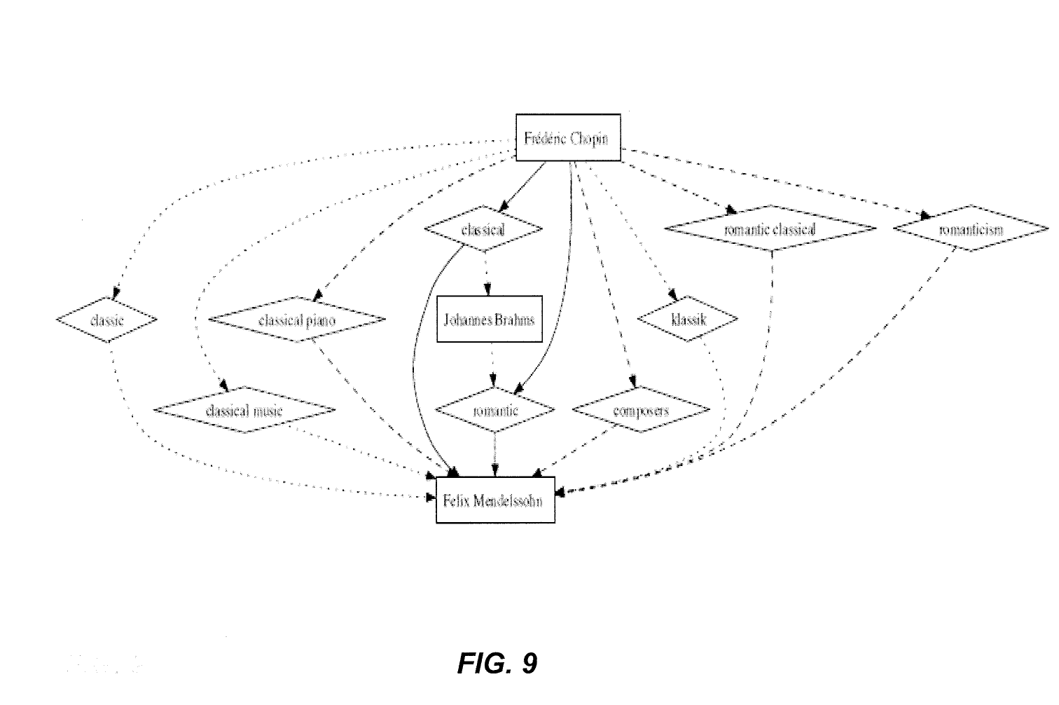

The first noteworthy observation is that the most similar results obtained using the method according to an embodiment of the present invention are all but one known as composers of the Romantic music era. Note that Chopin is considered as one of the most influential composers of Romantic music. The only composer that is not from the Romantic era is Ron Pope, who is a modern composer of classical piano music. Further noteworthy is that two of the related composers (Schuman and Brahms) are greatly influenced by Chopin. Also, when examining the functional hypotheses between Chopin and Mendlssohn, it is clear that the tag “romantic” plays an important role in the random walk from Chopin to Mendlssohn. Paths linking Chopin and Mendlssohn as determined according to an embodiment of the present invention are shown in FIG. 9. Besides the romantic tag, the classic tag and its many variations are also of great influence. Further interesting is the relatively high impact of the tags composer and classical piano.

In contrast to the above results, the predictions posed by the RWR approach reveal that only three out of nine suggested composers are from the Romantic era. Three out of nine are composers from the 20^{th} century (Philip Glass, Yann Tiersen, Howard Shore) and have, in comparison with earlier classical composers as Beethoven and Mozart, a prior importance in the last.fm graph that is almost ten times higher. Apparently, these 20^{th} century composers are far more popular for the last.fm audience. Another remarkable recommendation is the high similarity between Radiohead and Chopin. Radiohead is the most important artist in the last.fm network (see Table 2), and is a well-known alternative rock/indie band. Examining the paths between Chopin and Radiohead reveals that practically all paths go over the tag piano, which is an adequate tag for Chopin but seems less relevant for Radiohead.

1. A computer-implemented method for ranking information in an information system comprising linked objects, the method comprising
obtaining a prior value for each of a plurality of objects in the linked information system, the prior value being indicative of the importance of the object in the linked information system,
receiving an input comprising at least one source object,
determining a posterior value indicative of the probability to be reached for each of the plurality of objects utilizing random walk with restart in the at least one source object,
determining a ranking of the plurality of objects in the information system utilizing the determined posterior value and applying a correction factor inversely related with said computed prior value of the objects, and
providing an output being a set of objects selected based on the ranking of the plurality of objects in the information system.

2. The method according to claim 1, wherein obtaining a prior value comprises obtaining a prior probability being the probability to be reached for each of a plurality of objects in the linked information system utilizing a random walk with random restart operator.

3. The method according to claim 1, wherein applying a correction factor inversely related to said obtained prior value of the objects is weighting with a factor inversely proportional to said obtained prior value of the objects.

4. The method according to claim 1, wherein determining a posterior value comprises considering adjacency of objects in the information system.

5. The method according to claim 1, wherein the information system comprises a group of sub-information systems.

6. The method according to claim 1, the method comprising applying a user-specific or source object specific filter.

7. The method according to claim 6, wherein applying a filter is performed on the plurality of objects of the information system used for obtaining a prior value and obtaining a posterior value.

8. The method according to claim 6, wherein applying a filter is performed during or after determining the ranking of the plurality of objects.

9. A system for ranking information in an information system comprising linked objects, the system comprising
means for obtaining a prior value for each of a plurality of objects in the linked information system, the prior value indicative of the importance of the object in the linked information system,
means for obtaining an input comprising at least one source object,
means for determining a posterior value being indicative of the probability to be reached for each of the plurality of objects utilizing random walk with restart in the at least one source object,
means for determining a ranking of the plurality of objects in the information system utilizing the determined posterior value and applying a correction factor inversely related with said computed prior value of the objects, and
means for providing an output being one or more objects selected based on the ranking of the plurality of objects in the information system.

10. The system according to claim 9, wherein the prior value-obtaining means comprises a means for obtaining a prior probability, the prior probability being indicative of a probability to be reached for each of a plurality of objects in the linked database utilizing a random walk with random restart operator.

11. The system according to claim 9, wherein the system further comprises a means for filtering the plurality of objects or the ranking of the plurality of objects.

12. A computer-implemented method for obtaining information from an information system, the method comprising
receiving an input comprising at least one source object, and
determining a ranking of a plurality of objects in the information system, utilizing the method according to claim 1.

13. A computer program product for performing, when executed on a computing device, ranking information in an information system according to the method according to claim 1.

14. A web application for performing a method of ranking information according to claim 12.

15. A machine-readable data storage device storing the computer program product of claim 13.

16. Transmission of the computer program product of claim 13 over a local or wide area telecommunications network.

17. A computer-implemented method for determining at least one probable path between at least one source object and a target object in an information system comprising linked data objects, the method comprising
obtaining an input comprising a target object and at least one source object,
obtaining a posterior value for objects in the information system being indicative of a probability of reaching an object in the information system by random walk with restart in the at least one source object,
backtracking from the target object to the at least one source object guided by objects on the path having a higher posterior value than objects already present upstream the path from target object towards the at least one source object, and
providing an output comprising the at least one probable path based on said backtracking.

18. The method according to claim 17, wherein backtracking comprises the steps of:
declaring the target object as last object in a current partial path,
for each current partial path, determining new partial paths by adding objects to the current partial path, the objects having a higher probability to be reached by random walk with restart in the source than the objects already present in the current partial path,
limiting the total number of new partial paths from the target object towards the at least one source object based on the probability to follow the new partial paths, until a set of paths is obtained reaching from target object to the at least one source object,
declaring the limited number of new partial paths as current partial paths, and
repeating the determining and limiting steps.

19. The method according to claim 18, wherein for limiting the total number of new partial paths, the probability to follow a new partial path is determined by the probability to arrive at the last added object in this partial path based on random walk with restart in the at least one source object combined with the probability of following this partial path based on random walk from this last added object to the target object.

20. The method according to claim 17, wherein obtaining a target object comprises performing a method for ranking a plurality of objects in an information system.

21. The method according to claim 17, wherein the information system comprises a group of sub-information systems.

22. A system for determining at least one probable path between at least one source object and a target object in an information system comprising linked data objects, the system comprising
means for obtaining an input comprising a target object and at least one source object,
means for obtaining a posterior value for objects in the information system being indicative of a probability of reaching an object in the information system by random walk with restart in the at least one source object,
means for backtracking from the target object to the at least one source object guided by objects on the path having a higher posterior probability than objects already present upstream the path from target object towards the at least one source object, and
means for providing an output comprising the at least one probable path based on said backtracking.

23. The system according to claim 22, wherein the backtracking means comprises:
means for declaring the target object as last object in a current partial path,
a partial path-determining means programmed for determining, for each current partial path, new partial paths by adding objects to the current partial path, the objects having a higher probability to be reached by random walk with restart in the source than the objects already present in the current partial path, and
a limiting means programmed for limiting the total number of new partial paths from the target object towards the at least one source object based on the probability to follow the new partial paths,
wherein the system is programmed for, until a set of paths is obtained reaching from target object to the at least one source object, utilizing the declaring means for declaring the limited number of new partial paths as current partial paths, and repetitively utilizing the determining means and limiting means.

24. A computer-implemented method for obtaining at least one probable path from at least one source object to a target object, the method comprising
providing at least one source object, and
obtaining at least one probable path from the at least one source object to a target object, the at least one obtained probable path determined utilizing the method according to claim 17.

25. A computer program product for performing, when executed on a computing device, determination of a probable path according to the method of claim 17.

26. A web application for performing the method according to claim 17.

27. A machine-readable data storage device storing the computer program product of claim 25.

28. Transmission of the computer program product of claim 25 over a local or wide area telecommunications network.
